(19) United States
(12) Patent Application Publication
(10) Pub. No.: US 2008/0170483 A1
(43) Pub. Date: Jul. 17, 2008

(54) SUPER RESOLUTION OPTICAL RECORDING MEDIUM

(75) Inventor: Joo-ho Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/858,340

(22) Filed: Sep. 20, 2007

(30) Foreign Application Priority Data
Jan. 15, 2007 (KR) 2007-4403

(51) Int. Cl. G11B 3/74

(52) U.S. Cl. 369/94

(57) ABSTRACT

A super resolution optical recording medium for preventing degradation of a reproducing signal, includes a substrate, a super resolution layer formed on the substrate, and having a super resolution aperture formed thereon. The super resolution aperture has a size smaller than a resolution limit of an emitted beam incident on the super resolution layer, and a recording layer disposed on a lower part or an upper part of the super resolution layer. A reaction temperature at which recording of the recording layer is performed, is higher than a super resolution temperature at which the super resolution aperture is formed. Accordingly, the degradation of the reproducing signal can be prevented remarkably improving the number of times information can be reproduced.

### CROSS-REFERENCE TO RELATED APPLICATION

This application claims the benefit of Korean Patent Application No. 2007-4403, filed on Jan. 15, 2007 in the Korean Intellectual Property Office, the disclosure of which is incorporated herein in its entirety by reference.

### BACKGROUND OF THE INVENTION

1. Field of the Invention

An aspect of the present invention relates to a super resolution optical recording medium, and more particularly, to a super resolution optical recording medium having a structure preventing degradation of a reproducing signal.

2. Description of the Related Art

Optical recording media are widely employed as information storage media for optical pickup devices for recording and/or reproducing information. As demands for new information storage media having higher recording densities have increased, the next generation of optical recording media has been developed based on a new technology concept.

Generally, when a wavelength of a light source for reproducing information from optical recording media is λ, and an aperture of an objective lens is NA, a resolution limit is λ/4NA. Although a recording mark can be formed to be extremely small, reproduction is impossible due to the resolution limit. That is, conventionally, since light having the wavelength λ cannot be used to detect a recording mark having a size smaller than λ/4NA, the reproduction of information represented by the small recording mark that is less than the resolution limit is impossible.

Recently, research has been conducted into optical recording media having a super-resolution near-field structure (super-RENS) (hereinafter, referred to as a ‘super resolution optical recording media’) in order to overcome such resolution limits. Since the super resolution optical recording media can reproduce information represented by a recording mark having a small size which surpasses the resolution limit, the super resolution optical recording media can remarkably meet demands for high density and high capacitance.

FIG. 1 is a cross-sectional view illustrating a conventional super resolution optical recording medium 10 which has been recently suggested. Referring to FIG. 1, a conventional super resolution optical recording medium 10 includes a substrate 11, a reflective layer 12, a first protective layer 13, a super resolution layer 14, a second protective layer 15, a recording layer 16, a third protective layer 17 and a cover layer 18 which are sequentially formed on the substrate 11. The super resolution layer 14 is a layer on which a super resolution phenomenon occurs, and aids recording and/or reproduction of a recording mark on the recording layer 16. The recording layer 16 may be formed of metal oxide. For example, the recording layer 16 may be formed of metal oxide such as AuO_{X}, PdO_{X}, PtO_{X} or AgO_{X}. Each of the first through third protective layers 13,15 and 17 functions as a heat sink, and is formed of ZnS—SiO₂ or the like.

The super resolution optical recording medium having the above structure reproduces data using a reproducing beam which is incident from above the cover layer 18 and proceeds through an objective lens. The reproducing beam passes through the recording layer 16 and the super resolution layer 14 to be reflected on the reflective layer 12. When the reproducing beam is irradiated on the super resolution layer 14, a super resolution phenomenon, where a super resolution aperture is formed on a central part of a light spot formed on the super resolution layer 14, occurs. The super resolution aperture is a transparent window having a size equal to or lesser of a resolution limit and is generated when an optical property is changed near a central part of the super resolution layer 14 on which the intensity of radiation is concentrated. Since light transmitted through the super resolution layer 14 has the size of the resolution limit or less due to the super resolution phenomenon, data of the recording layer 16, which is recorded having the size of the resolution limit or less, can be reproduced. Since the super resolution optical recording media can reproduce information represented by the recording mark having a small size, which surpasses the resolution limit, by using to the super resolution phenomenon of the super resolution layer 14, the super resolution optical recording media can remarkably meet demands for high density and high capacitance.

However, since the super resolution phenomenon of the super resolution layer 14 occurs near a melting point of a phase change material constituting the super resolution layer 14, a reproducing beam having a relatively higher power than that of a conventional optical recording medium is used. High temperature reproduction by the reproducing beam having high power considerably weakens the stability of a reproducing signal of the super resolution optical recording media.

FIGS. 2A and 2B are graphs illustrating a drop in a voltage level of a reproducing signal of a conventional super resolution optical recording medium. FIG. 2A is a graph illustrating a voltage of a reproducing signal in an initial state of a super resolution optical medium, and FIG. 2B is a graph illustrating a voltage of a reproducing signal in the case where the super resolution optical recording medium is repetitively reproduced about 1,000 times. Referring to FIGS. 2A and 2B, a voltage level of about 1.6 V is obtained when initially reproducing the optical recoding medium, but a voltage level of about 1.4 V is obtained after reproducing the optical recording medium about 1,000 times. Accordingly, it can be seen that a drop of a voltage level of about 12.5% occurs.

FIGS. 3A and 3B are views illustrating an amplitude variation and a fluctuation increase of a reproducing signal in a conventional super resolution optical recording medium. Referring to FIGS. 3A and 3B, an amplitude Aᵢ is about 59 mV when initially reproducing, but an amplitude A_{f} is about 10 mV after reproducing is performed about 1,000 times. Accordingly, it can be seen that a reduction in the amplitude is about 80%. In addition, since amplitude variations Fᵢ and F_{f} of the reproducing signal are both about 100 mV (that is, almost the same when initial reproducing or after reproducing is performed about 1,000 times), a fluctuation is increased from 2 to 10, where, fluctuations are defined as a value of an amplitude variation of the reproducing signal divided by amplitude.

According to such experimental data, degradation of recording properties occurs by 10% and more after reproducing is performed about 1,000 times in the conventional super resolution optical recording medium. Such degradation has been a great obstacle in the practical use of super resolution optical recording mediums.

One reason for the degradation of properties of the conventional super resolution optical recording medium is gas diffusion in a recording layer. When a laser beam for recording a mark is irradiated on the recording layer 16 formed of metal oxide such as PtO_{X}, a thermal reaction occurs on an area on which a light spot is incident on the recording layer 16. When a metal and oxygen are separated by the thermal reaction, oxygen expands to form a rigid bubble, and then a volume expansion occurs in the area on which the light spot is formed, to form a recording mark “m”.

FIG. 4 is an image of the recording mark “m” formed by the thermal reaction. Referring to FIG. 4, a white portion of “A” area is a bubble region on which the separated oxygen is spread, and a dark portion is the separated metal.

Meanwhile, a temperature at which a super resolution phenomenon occurs (hereinafter, referred to as a “super resolution temperature”) is near a melting point of the super resolution layer (14 of FIG. 1). For example, in Sb—Te alloy and Ge—Sb—Te alloy, the super resolution temperature is a high temperature in the range of 500 to 550° C. Since a diffusion phenomenon is usually in proportion to temperature, such high temperature reproduction induces a diffusion of oxygen on the recording mark “m” having a bubble type. Such diffusion of oxygen leads to the degradation of the reproducing signal.

Reproduction stability is required after reproducing is performed tens of thousands through hundreds of thousands of times for practical use of a super resolution optical recording medium. Therefore, such degradation of the reproducing signal due to a high temperature reproduction has been a great obstacle in the practical use of the super resolution optical recording medium.

### SUMMARY OF THE INVENTION

An aspect of the present invention provides a super resolution optical recording medium having a recording layer in which degradation of a reproducing signal does not occur even at high temperature reproducing.

According to an aspect of the present invention, there is provided a super resolution optical recording medium including a substrate, a super resolution layer formed on the substrate, and having a super resolution aperture formed thereon, and the super resolution aperture having a size smaller than a resolution limit of an emitted beam incident on the super resolution layer; and a recording layer disposed on a lower part or an upper part of the super resolution layer, wherein a reaction temperature at which recording of the recording layer is performed, is higher than a super resolution temperature at which the super resolution aperture is formed.

According to another aspect of the present invention, the recording layer may be formed of a material wherein recording is performed without generating a gas.

According to another aspect of the present invention, the reaction temperature at which recording of the recording layer is performed, may be higher than the melting point of the super resolution layer by at least 200° C.

According to another aspect of the present invention, the recording layer may be formed of at least one selected from the group consisting of BaTiO₃, BaTiO₃+Y_{0.02}, Fe₂O₃, TiO₂, BaO and CoO₂.

According to another aspect of the present invention, the super resolution layer may be formed of at least one selected from the group consisting of a Sb—Te based alloy, a Ge—Sb—Te based alloy and an Ag—In—Sb—Te based alloy.

According to another aspect of the present invention, the super resolution optical recording medium may further include an anti substrate degradation layer interposed between the substrate and the reflective layer.

According to another aspect of the present invention, the anti substrate degradation layer may be formed of at least one selected from the group consisting of ZnS—SiO₂, GeN, SiN and SiO₂.

According to another aspect of the present invention, anti-diffusion layers may be formed on upper and lower surfaces of the super resolution layer.

According to another aspect of the present invention, the anti-diffusion layers may be formed of at least one selected from the group consisting of GeN, SiN and SiO₂.

According to another aspect of the present invention, there is provided an apparatus for recording and/or reproducing the super resolution recording medium. The apparatus (not shown) includes a light processing unit for emitting a beam onto the super resolution optical recording medium, a control unit controlling the movement and power of the beam, and a memory unit for storing information recorded and/or read onto/from the super resolution optical recording medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating a conventional super resolution optical recording medium;

FIGS. 2A and 2B are graphs illustrating a drop in voltage of a reproducing signal of a conventional super resolution optical recording medium with respect to the number of times of the super resolution optical recording medium of FIG. 1 is reproduced;

FIGS. 3A and 3B are views illustrating an amplitude variation and a fluctuation increase of a reproducing signal in a conventional super resolution optical recording medium with respect to the number of times the super resolution optical recording medium of FIG. 1 is reproduced;

FIG. 4 is a TEM image of the recording mark “m” of the super resolution optical recording medium of FIG. 1;

FIG. 5 is a schematic cross-sectional view illustrating a super resolution optical recording medium according to an embodiment of the present invention;

FIG. 6 is a TEM image of cross-sectional view illustrating a recording layer of the super resolution optical recording medium of FIG. 5;

FIG. 7 is a TEM image of amorphous cluster of a recording layer of the super resolution optical recording medium of FIG. 5;

FIG. 8 is a view illustrating a super resolution optical recording medium according to another embodiment of the present invention; and

FIGS. 9A and 9B are graphs illustrating reproducing stability of a super resolution optical recording medium with respect to the number of times the optical recording medium is reproduced, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

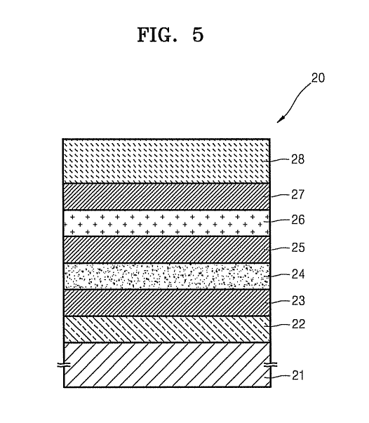

FIG. 5 is a schematic cross-sectional view illustrating a super resolution optical recording medium 20 according to an embodiment of the present invention. Referring to FIG. 5, the super resolution optical recording medium 20 includes a substrate 21, a reflective layer 22, a first protective layer 23, a super resolution layer 24, a second protective layer 25, a recording layer 26, a third protective layer 27 and a cover layer 28 which are sequentially formed on the substrate 21. While not limited thereto, the substrate 21 is formed of one selected from the group consisting of polycarbonate, polymethyl methacrylate (PMMA), amorphous polyolefin (APO) and glass.

While not limited thereto, the reflective layer 22 is formed of an Ag alloy such as AgPdCu. The first through third protective layers 23, 25 and 27 are each a dielectric layer thermally and mechanically protecting the super resolution layer 24 and the recording layer 26, and are each formed of at least one selected from the group consisting of oxide, nitride, carbide and fluoride. While not limited thereto, the first through third protective layers 23, 25 and 27 are each formed of at least one selected from the group consisting of SiOₓ, MgOₓ, AlOₓ, TiOₓ, VOₓ, CrOₓ, NiOₓ, ZrOₓ, GeOₓ, ZnOₓ, SiNₓ, AlNₓ, TiNₓ, ZrNₓ, GeNₓ, SiC, ZnS, ZnS—SiO₂ and MgF₂. The first through third protective layers 23, 25 and 27 may be formed of a dielectric substance not including a material such as sulfur (S) which has high diffusiveness. This minimizes inter-diffusion of the material of the first through third protective layers 23, 25 and 27 into the super resolution layer 24 or the recording layer 26 at a high temperature at which a super resolution phenomenon occurs.

The super resolution layer 24 is a layer aiding recording and/or reproducing of a recording mark formed on the recording layer 26, and is formed of a phase change material causing a super resolution phenomenon. While not required in all aspects, the phase change material may be an Se—Te based alloy, a Ge—Sb—Te based alloy, a Ge—In—Sb—Te based alloy or the like. For example, the composition of the super resolution layer 24 may be GST=Ge 6.5%/Sb 72.5%/Te 21%.

When a laser beam having a predetermined power or a higher power is applied to the super resolution layer 24, a temperature rises to a melting point temperature or higher at which the phase change occurs in a central part of a light spot on which the intensity of radiation is concentrated. Accordingly, optical properties are changed, and a super resolution phenomenon occurs, where a beam having the size of a resolution limit or less is transmitted. The melting point, at which the phase change occurs, is a super resolution temperature. That is, a light spot, which is a point where a laser beam is incident, has a temperature distribution of a Gaussian type where a temperature is highest at a central part of the light spot, and the temperature decreases away from the central part of the light spot. An optical property variation occurs on the central part having a temperature higher than a super resolution temperature, at which point a super resolution phenomenon occurs. Due to such temperature distribution difference a super resolution aperture is formed. Such super resolution aperture allows reproducing of a recording mark having the size of a resolution limit or less than the resolution limit.

While not required in all aspects, the recording layer 26 is formed of a material having a reaction temperature, at which recording is performed, higher than the temperature at which a super resolution aperture of the super resolution layer 24 if formed. While not required in all aspects, the recording layer 26 may be formed of metal oxide by which recording can be performed without generating a gas. For example, the recording layer 26 may be at least one selected from the group consisting of BaTiO₃, BaTiO₃+Y_{0.02}, Fe₂O₃, TiO₂, BaO and CoO₂.

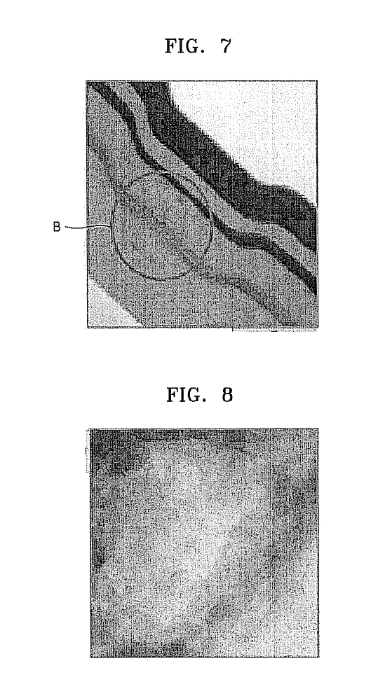

The recording layer 26 records information using a reflectivity difference between a crystal portion and an amorphous portion. FIGS. 7 and 8 are TEM images of cross-sectional views illustrating a recording mark of the recording layer 26 formed of BaTiO₃. FIG. 7 illustrates that an external variation does not occur near an area (B area) where the recording mark is formed. FIG. 8 is a view of an amorphous cluster of the recording mark of the recording layer 26. The amorphous cluster of the recording layer 26 may be formed by partially melting the recording layer 26 using irradiation of a laser beam.

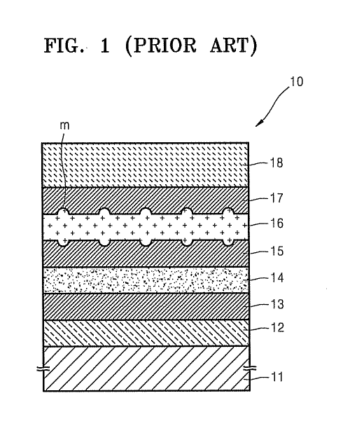

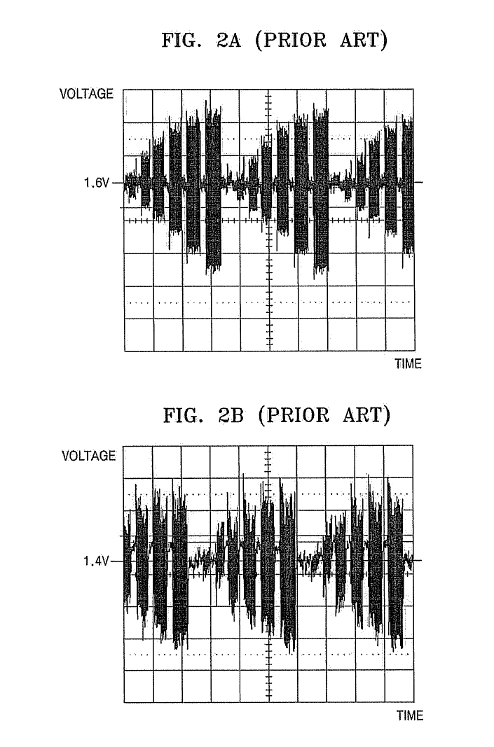

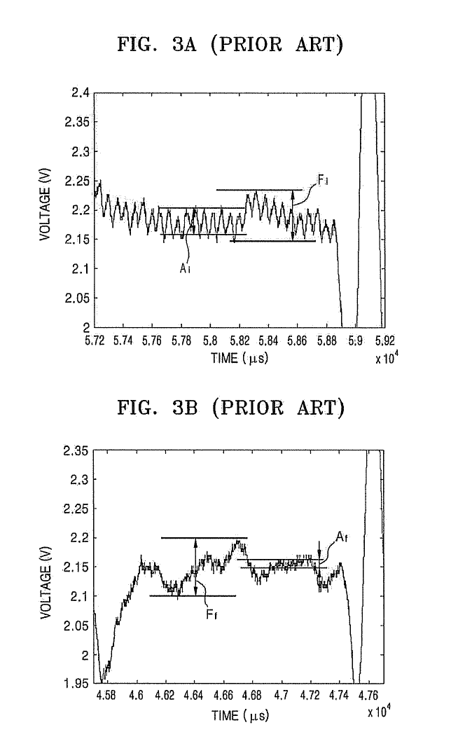

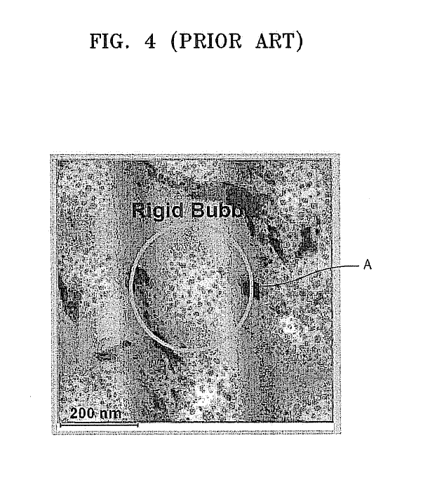

In a recording layer suggested in a conventional optical recording medium, such as that shown in FIG. 1, a gas is generated when forming a recording mark and then a rigid bubble is formed, as shown in FIG. 4. However, for aspects of the present invention, since a gas is not generated when the recording mark is formed due to its amorphous cluster structure, there is no external variation in the recording layer 26. Accordingly, in an aspect of the present invention, since a gas is not generated in the formation of the recording mark, a gas diffusion of the recording layer 26 is not induced due to a high temperature reproduction. Thus, signal degradation can be prevented.

According to aspects of the present invention, a melting point corresponding to a reaction temperature, at which a recording is performed on the recording layer 26, may be higher than a super resolution temperature, at which a super resolution aperture is formed, by at least 200° C., and the melting point of the recording layer 26 may be higher than 1000° C. The super resolution layer 24 is formed of Sb—Te alloy, and a super resolution temperature of Ge—Sb—Te alloy or Ge—In—Sb—Te base alloy of the super resolution layer 24 may be 500° C. through 550° C. Accordingly, the reaction temperature of the recording layer 26, at which a recording on a recording material is performed, may be higher than 750° C. For example, since the melting point of BaTiO₃ is 1625° C., and is over 1000° C. higher than a super resolution temperature, the recording layer 26 may be formed of BaTiO₃. Accordingly, since the melting point of the recording layer 26 is far higher than the super resolution temperature, the recording mark of the recording layer 26 is not changed even when reproducing at a super resolution temperature, thereby improving reproducing stability.

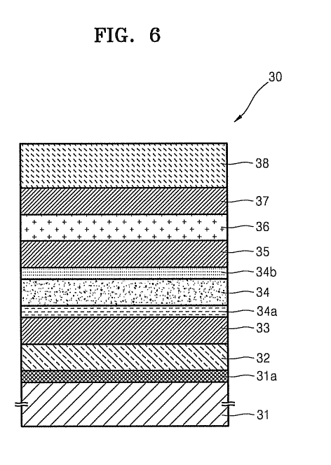

FIG. 6 is a schematic cross-sectional view illustrating a super resolution optical recording medium 30 according to another embodiment of the present invention. Referring to FIG. 6, the super resolution optical recording medium 30 includes a substrate 31, an anti substrate degradation layer 31a, a reflective layer 32, a first protective layer 33, a first anti-diffusion layer 34a, a super resolution layer 34, a second anti-diffusion layer 34b, a second protective layer 35, a recording layer 36, a third protective layer 37 and a cover layer 38 which are sequentially formed on the substrate 31.

Other elements of the super resolution optical recording medium 30 are substantially the same as those of the super resolution optical recording medium 20 of FIG. 5 except for the anti substrate degradation layer 31a and the first and the second anti-diffusion layers 34a and 34b. Thus the super resolution optical recording medium 30 will be described in terms of the differences from the super resolution optical recording medium 20 illustrated with reference to FIG. 5

The anti substrate degradation layer 31a may be formed of ZnS—SiO₂, GeN, SiN, and/or SiO₂. The thickness of the anti substrate degradation layer 31a may be less than or equal to 20 nm. As a reproduction of the super resolution optical recording medium 30 is performed at a temperature of 500° C. through 550° C., the substrate 31 formed of a material such as polycarbonate may deteriorate. Accordingly, the anti substrate degradation layer 31a prevents the deterioration of the substrate 31.

The first and second anti-diffusion layers 34a and 34b are each formed of a dielectric substance having a low reactivity at a high temperature such as a super resolution temperature. For example, the first and second anti-diffusion layers 34a and 34b may be each formed of at least one selected from GeN, SiN and/or SiO₂. The thickness of each of the first and second anti-diffusion layers 34a and 34b may be less than or equal to 3 nm. In the case of a conventional super resolution optical recording medium 10 as shown in FIG. 1, a protective layer formed of ZnS—SiO₂ is formed on upper and lower surfaces of a super resolution layer 14 in order to prevent a deterioration phenomenon of the super resolution layer 14, but deterioration occurs due to inter-diffusion between the super resolution layer 14 and the protective layer when high temperature reproducing is performed. However, according to the current embodiment of the present invention, the inter-diffusion between the super resolution layer 34 and the first and second protective layers 33 and 35 can be prevented due to the first and second anti-diffusion layers 34a and 34b, and thus the deterioration phenomenon can be prevented.

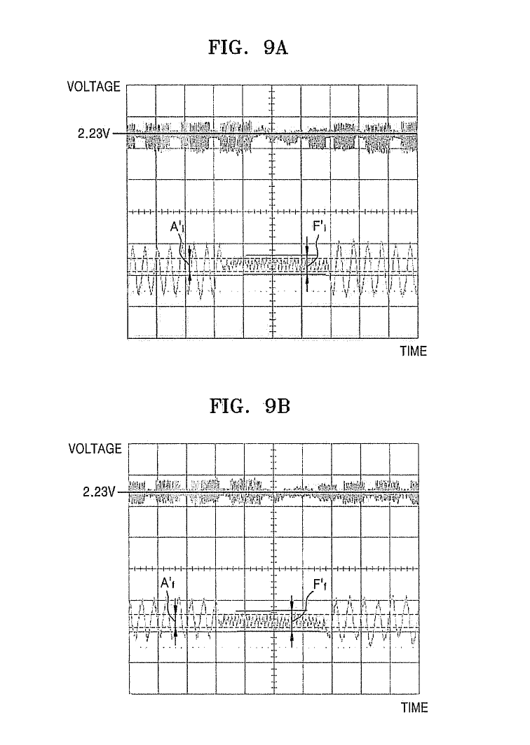

FIGS. 9A and 9B are graphs of experimental data illustrating reproducing stability of a super resolution optical recording medium, according to an embodiment of the present invention. FIG. 9A illustrates a voltage level, an amplitude Aᵢ′ and an amplitude variation Fᵢ′ when initial reproducing is performed. FIG. 9B illustrates a voltage level, an amplitude A_{f}″ and an amplitude variation F_{f}″ after reproducing is performed 100,000 times.

The super resolution optical recording medium 30 of FIG. 6 is used in the experiment. The super resolution optical recording medium 30 used in the experiment has a structure including a substrate 30/the anti substrate degradation layer 31a/the reflective layer 32/the first protective layer 33 the first anti-diffusion layer 34a/the super resolution layer 34 the second anti-diffusion layer 34b/the second protective layer 35/the recording layer 36 the third protective layer 37 which is formed of, in the current example, PC 320 nm thick/ZnS—SiO₂ greater than 0 and at or at least 20 nm thick/AgPdCu 40 nm thick/ZnS—SiO₂ 15 nm thick/GeN 3 nm thick/GeSbTe 10 nm thick/GeN 3 nm thick/ZnS—SiO₂ 35 nm thick/BaTiO₂ greater than 10 and at or at least 15 nm thick/ZnS—SiO₂ 110 nm thick, respectively. Recording is performed using a laser beam having a power of 6 mW in the super resolution optical recording medium, and then reproduction is performed using a laser beam having a power of 2 mW.

Referring to FIG. 9A, a voltage level, an amplitude Aᵢ′ and an amplitude variation Fᵢ′ are about 2.23 V, 85 mV and 150 mV at initial reproduction, respectively. A fluctuation, defined as a value of the amplitude variation of a reproducing signal divided by the amplitude is about 1.76. Referring to FIG. 9B, a voltage level, an amplitude A_{f}″ and an amplitude variation F_{f}″ are about 2.23 V, 85 mV and 170 mV, respectively, after reproducing is performed 100,000 times and a fluctuation is 2. Accordingly, it can be seen that the super resolution optical recording medium has no substantial change in the voltage level or the amplitude of the reproducing signal even after reproducing is performed 100,000 times, but the fluctuation of the reproducing signal is increased by 13.6%, that is, from 1.76 to 2.00.

As described above, in a super resolution optical recording medium according to an aspect of the present invention, a recording layer is formed of a material having a reaction temperature at which recording is performed, the reaction temperature being higher than a melting point at which a super resolution aperture of a super resolution layer is formed, and furthermore an anti substrate degradation layer or an anti-diffusion layer is used. Thus, stability in high temperature reproducing can be remarkably increased.

According to another aspect of the present invention, there is provided an apparatus for recording and/or reproducing the super resolution recording medium described above. The apparatus (not shown) includes a light processing unit for emitting a beam onto the super resolution optical recording medium for forming the mark on the recording layer and the aperture on the super resolution layer, a control unit controlling the functioning of the beam, and a memory unit for storing information related to the super resolution optical recording medium and to the beam.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A super resolution optical recording medium comprising:
a substrate;
a super resolution layer formed on the substrate on which, when irradiated to a super resolution temperature, a super resolution aperture is formed thereon, the aperture having a size smaller than a resolution limit of an emitted beam incident on the super resolution layer; and
a recording layer disposed on a lower part or an upper part of the super resolution layer on which can be formed a mark having a size at or less than the resolution limit of the emitted beam when irradiated to a reaction temperature,
wherein the reaction temperature is higher than the super resolution temperature.

2. The super resolution optical recording medium of claim 1, wherein the recording layer is formed of a material wherein recording is performed without generating a gas.

3. The super resolution optical recording medium of claim 1, wherein the reaction temperature at which recording of the recording layer is performed, is higher than the super resolution temperature by at least 200° C.

4. The super resolution optical recording medium of claim 1, wherein the recording layer is formed of at least one material selected from the group consisting of BaTiO₃, BaTiO₃+Y_{0.02}, Fe₂O₃, TiO₂, BaO and CoO₂.

5. The super resolution optical recording medium of claim 1, wherein the super resolution layer is formed of at least one material selected from the group consisting of a Sb—Te based alloy, a Ge—Sb—Te based alloy and an Ag—In—Sb—Te based alloy.

6. The super resolution optical recording medium of claim 1, further comprising:
a reflective layer formed on the substrate, and disposed below the super resolution layer and the recording layer.

7. The super resolution optical recording medium of claim 6, further comprising:
an anti substrate degradation layer interposed between the substrate and the reflective layer and above the substrate.

8. The super resolution optical recording medium of claim 7, wherein the anti substrate degradation layer is formed of at least one material selected from the group consisting of ZnS—SiO₂, GeN, SiN and SiO₂.

9. The super resolution optical recording medium of claim 8, wherein a thickness of the anti substrate degradation layer is less than or equal to 20 nm and is greater than zero.

10. The super resolution optical recording medium of claim 1, further comprising:
a first protective layer formed on an upper surface of the super resolution layer and a second protective layer formed on a lower surface of the super resolution layer, and the first and second protective layers being formed of at least one material selected from the group consisting of oxide, nitride, carbide and fluoride.

11. The super resolution optical recording medium of claim 10, further comprising:
a third protective layer formed on an upper surface of the recording layer, and formed of at least one material selected from the group consisting of oxide, nitride, carbide and fluoride.

12. The super resolution optical recording medium of claim 10, wherein the first and second protective layers are formed of at least one material selected from the group consisting of SiOₓ, MgOₓ, AlOₓ, TiOₓ, VOₓ, CrOₓ, NiOₓ, ZrOₓ, GeOₓ, ZnOₓ, SiNₓ, AlNₓ, TiNₓ, ZrNₓ, GeNₓ, SiC, ZnS, ZnS—SiO₂ and MgF₂.

13. The super resolution optical recording medium of claim 10, further comprising:
a first anti-diffusion layer interposed between the super resolution layer and the first protective layer; and
a second anti-diffusion layer interposed between the super resolution layer and the second protective layer.

14. The super resolution optical recording medium of claim 13, wherein the first and second anti-diffusion layers are formed of at least one material selected from the group consisting of GeN, SiN and SiO₂.

15. The super resolution optical recording medium of claim 13, wherein the thickness of each of the first and second anti-diffusion layer is less than or equal to 3 nm.

16. The super resolution optical recording medium of claim 1, wherein the super resolution temperature is substantially the melting temperature of the super resolution layer.

17. A super resolution optical recording medium comprising:
a substrate;
a super resolution layer formed on the substrate on which, when irradiated to a super resolution temperature, forms a super resolution aperture, the aperture having a size smaller than a resolution limit of an emitted beam incident on the super resolution layer; and
a recording layer disposed on a lower part or an upper part of the super resolution layer which forms a mark when irradiated to a reaction temperature,
wherein when the recording mark is formed on the recording layer, gas diffusion is prevented due to a difference between the reaction temperature at which the recording mark is formed and the super resolution temperature at which the super resolution aperture is formed.

18. The super resolution optical recording medium of claim 17, wherein the recording layer is formed of at least one selected from the group consisting of BaTiO₃, BaTiO₃+Y_{0.02}, Fe₂O₃, TiO₂, BaO and CoO₂.

19. The super resolution optical recording medium of claim 18, wherein the super resolution layer is formed of at least one material selected from the group consisting of a Sb—Te based alloy, a Ge—Sb—Te based alloy and an Ag—In—Sb—Te based alloy.

20. The super resolution optical recording medium of claim 17, wherein the difference between the reaction temperature and the super resolution temperature is at or greater than 200° C.

21. The super resolution optical recording medium of claim 20, wherein the reaction temperature is substantially the melting temperature of the recording layer and the super resolution temperature is substantially the melting temperature of the super resolution layer.

22. The super resolution optical recording medium of claim 17, wherein the reaction temperature is greater than the super resolution temperature.

23. The super resolution optical recording medium of claim 17 further comprising:
a first protective layer formed on an upper surface of the super resolution layer and a second protective layer formed on a lower surface of the super resolution layer, and the first and second protective layers being formed of at least one material selected from the group consisting of oxide, nitride, carbide and fluoride.

24. A method of forming a super resolution aperture on a super resolution layer and forming a mark on a recording layer, the method comprising:
irradiating the super resolution layer to a super resolution temperature with a beam forming the super resolution aperture thereon, the aperture having a size smaller than a resolution limit of the beam incident on the super resolution layer;
irradiating the recording layer to a reaction temperature forming the recording mark having a size at or less than the resolution limit of the emitted beam, the recording layer disposed on a lower part or an upper part of the super resolution layer,
wherein the reaction temperature is higher than the super resolution temperature.
